(19) United States
(12) Patent Application Publication
(10) Pub. No.: US 2003/0206984 A1
(43) Pub. Date: Nov. 6, 2003

(54) Air introduction valve for a mold assembly

(76) Inventor: Gerard Jay Bellasalma, Yorba Linda, CA (US)

Correspondence Address: CARLSON, GASKEY & OLDS, P.C., 400 WEST MAPLE ROAD, SUITE 350, BIRMINGHAM, MI, 48009, US

(21) Appl. No.: 10/136,496

(22) Filed: May 1, 2002

(51) Int. Cl. B29C 45/17

(52) U.S. Cl. 425/130

(57) ABSTRACT

An air injection valve assembly includes an actuator and a valve section. The valve section generally includes a valve body and a valve stem movable therein. The valve stem includes a valve head which mates with a valve seat when in the closed position. A valve head facing surface of the valve head is manufactured to be completely flush with a valve seat facing surface of the valve seat. The facing surfaces are preferably contoured to exactly match the interior contour of the mold cavity. When in the closed position the valve head blends into the mold cavity and thus minimizes the chance of a blemish being formed on the molded article.

### BACKGROUND OF THE INVENTION

The present invention relates to a molding machine, and more particularly to a valve assembly which minimizes the possibility of leaving an unsightly blemish in a finished article.

Many molding machines provide for the mixing of at least two fluid materials to form a hardenable or settable mixture which is discharged into a mold cavity to form the finished article. Once the mixture has substantially cured, the molded article must be removed from the cavity without damaging the article. It is known to introduce air between the molded article and the cavity to assist in separating the article therefrom. Typically, a vent is located in the mold such that air can be injected at strategic locations between the molded article and the cavity.

The valve, however, may disadvantageously disturb the molded article. One known valve is a mechanically operated spring-loaded valve. The valve is opened against the spring force by a mechanical linkage such that air may be injected into the mold. After air injection, the valve is closed by the spring. Disadvantageously, the known valve opens into the cavity and may ingest some of the uncured mixture. Mixture buildup eventually may lead to valve failure.

The known valve may further disturb the curing mixture during opening which may result in a blemish on the finished molded component. The valve is thus typically located in a region of the mold cavity which will not be visible on the finished product or is located in an area which will be later removed, for example, the drain location of a bathtub. Some molded articles, however, do not have such a non-visible or removable region. Further, it is preferable to provide multiple air injection sites to assure that the article will be properly released. Preferred sites which assure release may not be located in these non-visible or removable areas.

Accordingly, it is desirable to provide an air induction valve which may be located anywhere in the mold cavity to assure proper article release while minimizing the chance of leaving an unsightly blemish in the finished article.

### SUMMARY OF THE INVENTION

The air injection valve assembly according to the present invention mounts to a mold assembly to selectively injects a gas such as air into the mold assembly. The valve assembly generally includes an actuator and a valve section.

The actuator operates the valve section and preferably includes a pneumatically driven actuator such as a pneumatic piston. The valve section generally includes a valve body and a valve stem movable therein. The valve stem includes a valve head which mates with a valve seat when in the closed position. A valve head facing surface of the valve head is manufactured to be completely flush with a valve seat facing surface of the valve seat. The facing surfaces are preferably contoured to exactly match the interior contour of the mold cavity. When in the closed position the valve head blends into the mold cavity and thus minimizes the chance of a blemish being formed on the molded article.

The inventors of the present invention have determined that one of the major factors contributing to a blemish being formed in a finished molded article is rotation of the valve member. The valve member rotates the curing material which forms a blemish. An anti-rotation assembly extends from the valve stem to prevent rotation of the valve head relative to the valve seat.

The valve assembly preferably includes a multiple of removable body segments such that multiple installation possibilities are realized. Preferably, the valve assembly includes threads which mate with corresponding threads on the mold assembly such that the valve assembly can be screwed into place. Further, other mounting arrangements are realized by replacing particular segments of the valve assembly.

The present invention therefore provides an air induction valve which may be located anywhere in the mold cavity to assure proper article release while minimizing the chance of leaving an unsightly blemish in the finished article.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a simplified schematic representation of a multiple material molding system;

FIG. 2A is an exploded partial sectional view of a air injector valve assembly according to the present invention;

FIG. 2B is an exploded partial sectional view of the air injector valve assembly of FIG. 2A in an open position; and

FIG. 2C is an exploded partial sectional view of another mounting arrangement for an air injector valve assembly according to the present invention.

### DETAILED DESCRIPTION OF THE PREFERRED EMBODIMENT

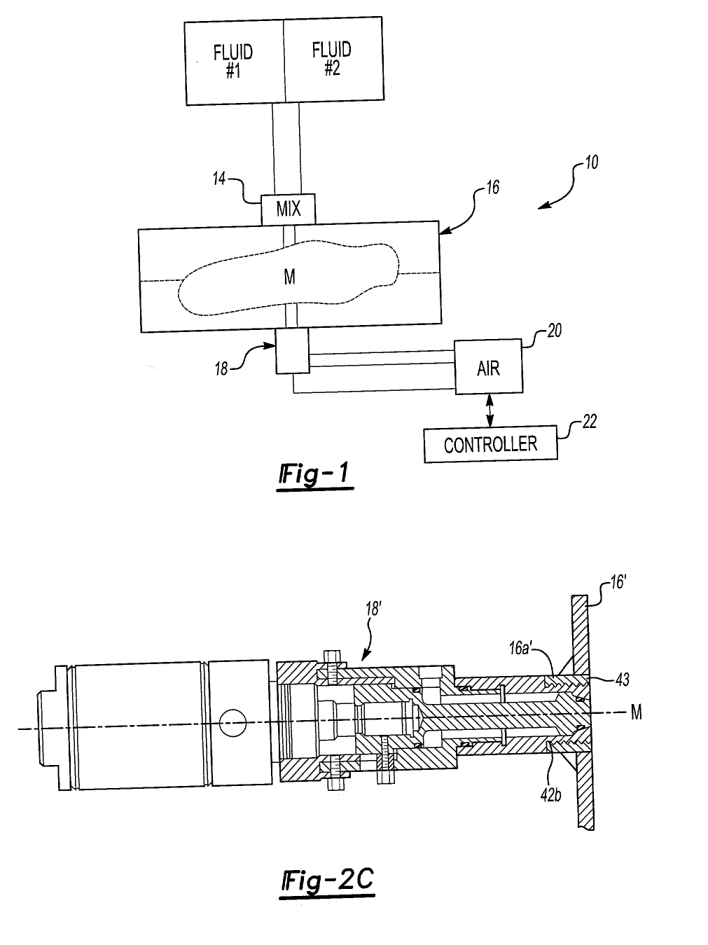

FIG. 1 schematically illustrates a multiple material molding system 10. The system 10 generally includes a plurality of fluid material supplies 12A, 12B which are communicated to a mix head assembly 14. The mix head assembly 14 thoroughly mixes the fluid material from each fluid material supply 12A, 12B and injects the final mixture into a mold assembly 16 or the like.

An air injection valve assembly 18 is mounted to the mold assembly 16. The valve assembly 18 is preferably threaded into the mold assembly 16, however, other attachment arrangements will benefit from the present invention. The valve assembly selectively injects a gas such as air from a source 20 such as a compressor into the mold assembly 16. Preferably, a controller 22 communicates with the source to selectively actuate the valve assembly 18 and to assure the system 10 is operating within predefined parameters. Controls for injection-molding equipment and air injection are known in the art and further description of the algorithms will not be further detailed herein. System 10 is preferably utilized for injection molding of very large parts, and in particular bath tubs and shower surrounds. It should be further understood that although only a single valve assembly is illustrated in the disclosed embodiment, it is preferred that a plurality of valves are located in the mold at strategic locations to assure proper release of the molded component.

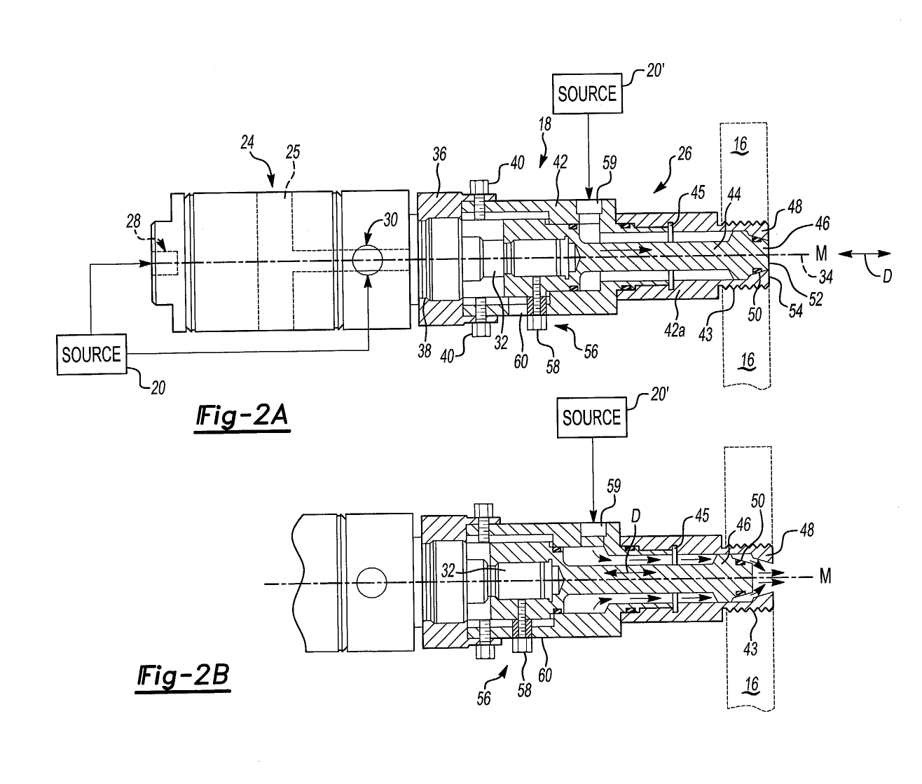

Referring to FIG. 2A, a partial sectional view of the air injection valve assembly 18 according to the present invention is illustrated. The valve assembly 18 generally includes an actuator 24 and a valve section 26.

The actuator 24 operates the valve section 26 and preferably includes a pneumatically driven actuator such as a pneumatic piston (illustrated schematically at 25), however, other actuators such as electrical actuators will also benefit from the present invention. A first activation input port 28 and a second actuation input port 30 communicates with the source 20. By communicating air pressure through the first activation input port 28, the drive stem 32 will be driven in a first direction. Communication of air pressure to the second actuation input port 30 will drive the drive stem 32 in the opposite direction. Movement of the drive stem 32 along valve axis 34 is schematically illustrated by double headed arrow D.

Preferably, the actuator 24 is threadably received into a mounting collar 36 by complementary threads 38. Mounting collar 36 attaches the actuator 24 to the valve section 26 with threaded fasteners 40 or the like. Maintenance or replacement is thereby facilitated.

The valve section 26 generally includes a valve body 42 and a valve stem 44 movable therein. A removable valve body portion 42a provides to installation of the air injection valve assembly 18 into the mold assembly 16 by complementing threads 43. This installation arrangement is particularly applicable to a rather thick walled section of the mold assembly 16. It should be further understood that the valve body portion which includes threads 43 is particularly tailored to the depth between the mold cavity (FIG. 1) and the outer surface of mold assembly 16. In other words, by replacing removable valve body portion 42a, many mold assembly locations may advantageously receive valve assembly 18. It should be understood that although a multi-segment valve body 42 is illustrated in the disclosed embodiment, a one-piece valve body will also benefit from the present invention.

The valve stem 44 is mounted to the drive stem 32 and is selectively drivable thereby. A guide 45 such as a bushing is preferably located in the valve body portion 42, to guide motion of valve stem 44. The valve stem 44 includes a valve head 46 which mates with a valve seat 48 when in the closed position. The valve head 46 preferably includes a seal 50 such as an O-ring which further assures that the valve head closely mates with the valve seat 48 (also illustrated in FIG. 2B; valve illustrated in the open position).

Preferably, a valve head facing surface 52 of the valve head 46 is manufactured to be completely flush with a valve seat facing surface 54 of the valve seat 48. It should be understood that the facing surfaces 52,54 are preferably contoured to exactly match the contour of the mold cavity M (FIG. 1). When in the closed position, the valve head 46 blends into the mold cavity M and thus minimizes the chance of a blemish being formed on the molded article. In other words, the valve head 46 and valve seat 48 are formed such as during the final mold assembly 16 shaping so that the facing surfaces 52,54 form a portion of the mold cavity M and completely blend in.

An air injection port 59 is located in the valve body 42 to receive air from a source 20′. When the valve stem is in the open position (FIG. 2B), air (illustrated schematically as arrows a) is communicated from the air injection port 59; adjacent the valve stem 44; passed the valve head 46; out the valve seat 48; and into the mold cavity M. Preferably, source 20′ is distinct from source 20 to assure that clean air is injected into the mold cavity. However, a common source will also benefit from the present invention.

An anti-rotation assembly 56 extends from the valve stem 44 to prevent rotation thereof. The anti-rotation assembly 56 preferably includes a locator 58 which extends from the valve stem 44 and through a slot 60 in the valve body 42. The locator 58 is preferably a threaded fastener which thread into corresponding threads in the valve stem 44. The locator 58 is thereby removable to simplify maintenance and disassembly of the valve body 42.

The inventors of the present invention have determined that one of the major factors contributing to a blemish being formed in a finished molded article is rotation of the valve member. The valve member may rotate when in operation in contact with the curing material. This may form a blemish. The anti-rotation assembly 56 prevents rotation of the valve head 46 relative to the valve seat 48. Further, the valve head 46 and valve seat 48 are preferably contoured to exactly match the interior contours of the mold interior M. The facing surface 52 of the valve head 46 must therefore be consistently aligned with the facing surface 54 of the valve seat 48 to assure that the proper contour is maintained. The anti rotation assembly 56 assures such alignment.

Notably, the valve head 46 is of a frustro-conical construction such that an extremely tight positional relation is assured between the valve head 46 and valve seat 48 when in the closed position (FIG. 2A). Additionally, as the valve head 46 opens into the valve seat 48, the valve head 46 will not disturb the curing mixture within mold cavity M. In other words, the valve head 46 is retracted from the mold cavity interior M and into the valve body 42 when in the open position (FIG. 2B). The chance of a blemish being formed on the molded article is thus further minimized.

Referring to FIG. 2C, another embodiment of the present invention is illustrated. The FIG. 2C embodiment provides another installation of an air injection valve assembly 18′ to a mold assembly 16′. As described above, the valve body 42, includes a body segment 42b to provide for installation in a receiver 16′a mounted in the mold assembly 16′. The receiver 16′a is fixed to the mold assembly 16′ by welding or the like. The valve assembly 18′ is threaded into receiver 16′a, as described above. The FIG. 2c installation arrangement particularly applicable to a rather thin area of the mold assembly 16′ which may require additional structural support. By so forming the valve body 42 of multiple segments various installation possibilities are realized.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An air introduction valve assembly for a mold comprising:
an actuator;
a valve body; and
a valve stem movable between an open position and a closed position by said actuator, said valve stem retracted into said valve body when in said open position.

2. The valve assembly as recited in claim 1, wherein said actuator includes a pneumatic actuator.

3. The valve assembly as recited in claim 2, wherein said actuator includes a first and a second actuator input.

4. The valve assembly as recited in claim 1, wherein said valve body includes a valve seat and said valve stem includes a valve head, said valve head matable with said valve seat.

5. The valve assembly as recited in claim 4, wherein said valve head is substantially frustro-conical.

6. The valve assembly as recited in claim 4, wherein said valve head includes a seal.

7. The valve assembly as recited in claim 1, wherein said valve seat includes a valve seat facing surface and said valve head includes a valve head facing surface, said facing surfaces being substantially flush with each other when in said closed position.

8. The valve assembly as recited in claim 1, wherein said valve seat includes a valve seat facing surface and said valve head includes a valve head facing surface, said facing surfaces substantially conforming to a mold cavity when in said closed position.

9. The valve assembly as recited in claim 1, further comprising an air input port in said valve body.

10. The valve assembly as recited in claim 1, further comprising an anti-rotation assembly to prevent rotation of said valve stem relative to said valve body.

11. An air introduction valve assembly for a mold comprising:
an actuator;
a valve body including a valve seat;
a valve stem including a valve head, said valve head movable between an open position and a closed position by said actuator, said valve head retracted into said valve seat when in said open position; and
an anti-rotation assembly to prevent rotation of said valve stem relative to said valve body.

12. The valve assembly as recited in claim 11, wherein said actuator includes a pneumatic actuator.

13. The valve assembly as recited in claim 12, wherein said actuator includes a first and a second actuator input.

14. The valve assembly as recited in claim 13, further comprising an air input port in said valve body.

15. The valve assembly as recited in claim 11, wherein said valve head is substantially frustro-conical.

16. The valve assembly as recited in claim 15, wherein said valve head includes a seal.

17. The valve assembly as recited in claim 11, wherein said valve seat includes a valve seat facing surface and said valve head includes a valve head facing surface, said facing surfaces being substantially flush with each other when in said closed position.

18. The valve assembly as recited in claim 11, wherein said valve seat includes a valve seat facing surface and said valve head includes a valve head facing surface, said facing surfaces substantially conforming to a mold cavity when in said closed position.

19. The valve assembly as recited in claim 11, wherein said valve body includes a plurality of body segments.
